(19) United States
(12) Patent Application Publication
(10) Pub. No.: US 2015/0229141 A1
(43) Pub. Date: Aug. 13, 2015

(54) FLOWING ELECTROLYTE BATTERY MAINTENANCE BUS SYSTEM AND METHOD

(71) Applicant: RedFlow R&D Pty Ltd, Seventeen Mile Rocks, Queensland (AU)

(72) Inventor: Alexander Rudolf Winter, Seventeen Mile Rocks (AU)

(21) Appl. No.: 14/419,753

(22) PCT Filed: Aug. 7, 2013
(86) PCT No.: PCT/AU2013/000868

§ 371 Date: Feb. 5, 2015

(30) Foreign Application Priority Data
Aug. 8, 2012 (AU) 2012903397

(51) Int. Cl. H02J 7/00; H01M 12/08

(52) U.S. Cl. CPC H02J 7/0019; H02J 7/0021; H02J 7/0057; H01M 12/085

(57) ABSTRACT

A flowing electrolyte battery system and a method of maintaining a flowing electrolyte battery system is provided. The flowing electrolyte battery system includes a power bus, a maintenance bus, and a plurality of flowing electrolyte batteries switchedly connected to the power bus or the maintenance bus. A bi-directional converter connects the maintenance bus and the power bus, and the bi-directional converter includes a step-up mode, for creating a positive potential difference between the maintenance bus and the power bus, and a step-down mode, for creating a negative potential difference between the maintenance bus and the power bus.

### FIELD OF THE INVENTION

The present invention relates to flowing electrolyte batteries. In particular, although not exclusively, the invention relates to a battery maintenance bus system including a plurality of flowing electrolyte batteries.

### BACKGROUND TO THE INVENTION

Flowing electrolyte batteries, such as zinc-bromine batteries, zinc-chlorine batteries, and vanadium flow batteries, are becoming increasingly popular in stand alone power supply systems and grid-connected systems. The useful lifetime of a flowing electrolyte battery is not affected by deep discharge applications, and the energy to weight ratio of flowing electrolyte batteries is up to six times higher than that of lead-acid batteries.

A flowing electrolyte battery, like a lead acid battery, comprises a stack of cells that produce a total voltage higher than that of the individual cells. But unlike a lead acid battery, cells in a flowing electrolyte battery are hydraulically connected through an electrolyte circulation path.

Referring to FIG. 1, a flow diagram illustrates a basic zinc-bromine flowing electrolyte battery 100, according to the prior art. The zinc-bromine battery 100 includes a negative electrolyte circulation path 105 and an independent positive electrolyte circulation path 110. The negative electrolyte circulation path 105 contains zinc ions as an active chemical, and the positive electrolyte circulation path 110 contains bromine ions as an active chemical. The zinc-bromine battery 100 also comprises a negative electrolyte pump 115, a positive electrolyte pump 120, a negative zinc electrolyte (anolyte) tank 125, and a positive bromine electrolyte (catholyte) tank 130.

To obtain high voltage, the zinc-bromine battery 100 further comprises a stack of cells connected in a bipolar arrangement. For example, a cell 135 comprises half cells 140, 145 including a bipolar electrode plate 155 and a micro porous separator plate 165. The zinc-bromine battery 100 then has a positive polarity end at a collector electrode plate 160, and a negative polarity end at another collector electrode plate 150.

A chemical reaction in a positive half cell, such as the half cell 145, during charging can be described according to the following equation:

2Br⁻→Br₂+2e⁻ Eq. 1

Bromine is thus formed in half cells in hydraulic communication with the positive electrolyte circulation path 110 and is then stored in the positive bromine electrolyte tank 130. A chemical reaction in a negative half cell, such as the half cell 140, during charging can be described according to the following equation:

Zn²⁺+2e⁻→Zn Eq. 2

A metallic zinc layer 170 is thus formed on the collector electrode plate 150 in contact with the negative electrolyte circulation path 105. Chemical reactions in the half cells 140, 145 during discharging are then the reverse of Eq. 1 and Eq. 2.

A problem with zinc-bromine batteries 100 of the prior art is that they require regular maintenance, and during this regular maintenance the battery 100 is often unavailable for use.

For example, it is advantageous to periodically strip a zinc-bromine battery 100, i.e. completely discharge, strip to zero volts and then recharge the zinc-bromine battery 100, to maintain its efficiency. During the stripping process all residual metallic zinc deposits are removed by chemical reaction with remaining dissolved bromine and the total battery voltage falls to zero volts. This process may be accelerated by electrically discharging or short circuiting the battery terminals down to zero volts.

Similarly, a zinc-bromine battery 100 is not particularly well suited in situations where the zinc-bromine battery 100 is used as a backup power source for non-scheduled power disruptions, as the zinc-bromine battery 100 is unable to supply power during the strip phase.

### OBJECT OF THE INVENTION

It is an object of some embodiments of the present invention to provide consumers with improvements and advantages over the above described prior art, and/or overcome and alleviate one or more of the above described disadvantages of the prior art, and/or provide a useful commercial choice.

### SUMMARY OF THE INVENTION

According to one aspect, the invention resides in a flowing electrolyte battery system including:

a power bus;

a maintenance bus;

a plurality of flowing electrolyte batteries switchedly connected to the power bus or the maintenance bus; and

a bi-directional converter connecting the maintenance bus and the power bus,

wherein the bi-directional converter includes a step-up mode, for creating a positive potential difference between the maintenance bus and the power bus, and a step-down mode, for creating a negative potential difference between the maintenance bus and the power bus.

Preferably, the system further includes a bidirectional inverter connected to the power bus, for converting between direct current (DC) of the power bus and alternating current (AC) of an external power network.

Preferably, the system further includes a controller, the controller including:

a sensor, for receiving a measurement of a flowing electrolyte battery of the plurality of flowing electrolyte batteries, and

at least one output, for regulating a component of the system;

wherein the output is controlled according to the received measurement.

Preferably, the measurement includes at least one of a voltage and a resistance of a battery of the plurality of flowing electrolyte batteries. More preferably, the measurement includes at least one of a voltage and a resistance of each battery of the plurality of flowing electrolyte batteries.

Preferably, the component of the system includes one of a switch, a pump of the battery and the bi-directional converter.

Preferably, the controller further includes:

a processor, coupled to the sensor and the output; and

a memory, coupled to the processor, including program code executable by the processor for performing maintenance procedures.

Preferably, the maintenance procedures include:

determining that a battery of the plurality of zinc-bromine batteries is fully charged;

disconnecting the battery from the power bus and turning off a zinc pump and a bromine pump of the battery;

periodically running the zinc pump while the battery is disconnected from the power bus; and

periodically reconnecting the battery to the power bus for recharging, including turning on the zinc pump and the bromine pump during recharging.

Preferably, the maintenance procedures include:

connecting the battery to the maintenance bus;

discharging the battery until a first threshold criterion is reached;

short circuiting the battery until a second threshold criterion is reached;

recharging the battery; and

reconnecting the battery to the power bus.

Preferably, the maintenance procedures include balancing the State of Charge (SoC) of the batteries by:

determining a first SoC of a first battery of the plurality of zinc-bromine batteries, wherein the first battery is connected to the power bus;

determining a second SoC of a second battery of the plurality, of zinc-bromine batteries, wherein the second battery is connected to the power bus and the first SoC is higher than the second SoC; and

performing one of:
connecting the first battery to the maintenance bus and discharging the first battery; or
connecting the second battery to the maintenance bus and charging the second battery.

According to another aspect, the invention resides in a method of maintaining a flowing electrolyte battery system, wherein the flowing electrolyte battery system includes a plurality of zinc-bromine batteries, each of the plurality of zinc-bromine batteries switchedly connected to a power bus and a maintenance bus, the method including:

determining that a battery of the plurality of zinc-bromine batteries is fully charged;

disconnecting the battery from the power bus and turning off a zinc pump and a bromine pump of the battery;

periodically running the zinc pump while the battery is disconnected from the power bus; and

periodically reconnecting the battery to the power bus for recharging, including turning on the zinc pump and the bromine pump during recharging.

Preferably, the method further includes:

connecting the battery to the maintenance bus;

discharging the battery until a first threshold criterion is reached;

short circuiting the battery until a second threshold criterion is reached;

recharging the battery; and

reconnecting the battery to the power bus.

Preferably, discharging the battery comprises creating a positive potential difference between the maintenance bus and the power bus by a direct current (DC)-DC converter.

Preferably, the battery is discharged at a constant current. More preferably, the constant current is about 50 milliamperes per square centimetre of electrode.

Preferably, the first threshold criterion is about 0.05 volt per cell across the battery.

Preferably, the second threshold criterion is about 0 volt across the battery maintained for a period of about 30 minutes.

Preferably, the battery is recharged on the maintenance bus.

Preferably, recharging the battery comprises creating a negative potential difference between the maintenance bus and the power bus by a direct current (DC)-DC converter to a specific SoC.

Preferably, the specific SoC comprises a SoC of another battery on the power bus.

Alternatively, the battery is charged on the power bus.

Preferably, the method further includes:

determining a first SoC of a first battery of the plurality of zinc-bromine batteries, wherein the first battery is connected to the power bus;

determining a second SoC of a second battery of the plurality of zinc-bromine batteries, wherein the second battery is connected to the power bus, wherein the first SoC is higher than the second SoC; and

performing one of:
connecting the first battery to the maintenance bus and discharging the first battery; or
connecting the second battery to the maintenance bus and charging the second battery.

According to another aspect, the invention resides in a flowing electrolyte battery system including:

a power bus;

a maintenance bus;

a plurality of flowing electrolyte batteries switchedly connected to the power bus or the maintenance bus; and

a power converter connecting the maintenance bus and the power bus,

wherein the power converter is configurable to generate a potential difference between the power bus and the maintenance bus such that batteries that are connected to the maintenance bus are charged.

Preferably, the power converter is configurable to convert between an alternating current of an external power network or a direct current of the power bus to a direct current of the maintenance bus, and an electrical load is used to discharge any batteries that are connected to the maintenance bus.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 illustrates a basic zinc-bromine flowing electrolyte battery, according to the prior art;

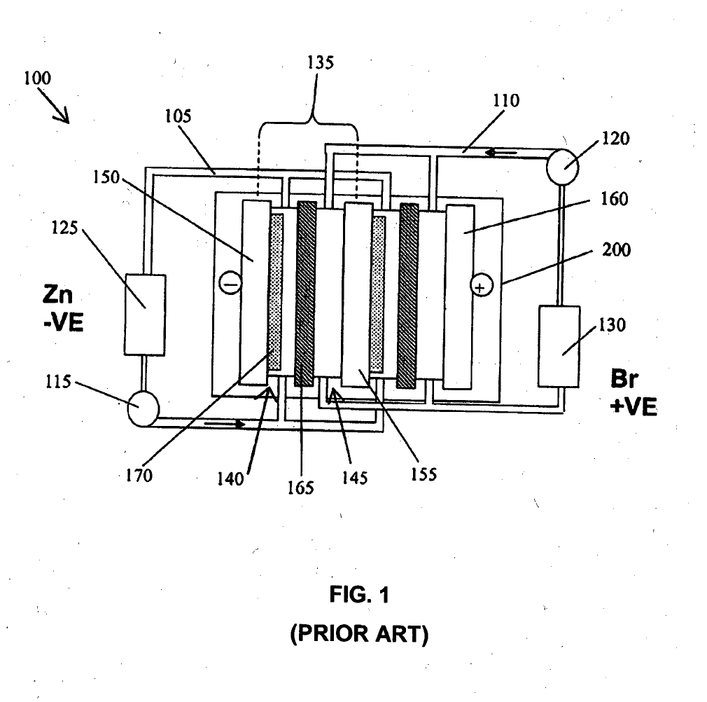

FIG. 2 illustrates a battery system, according to an embodiment of the present invention;

FIG. 3 illustrates a battery system, according to an embodiment of the present invention;

FIG. 4 illustrates a method of charge maintenance, according to an embodiment of the present invention;

FIG. 5 illustrates a method of maintaining a battery, according to an embodiment of the present invention;

FIG. 6 illustrates a method of balancing batteries, according to an embodiment of the present invention; and

FIG. 7 diagrammatically illustrates a controller, according to an embodiment of the present invention.

Those skilled in the art will appreciate that minor deviations from the layout of components as illustrated in the drawings will not detract from the proper functioning of the disclosed embodiments of the present invention.

### DETAILED DESCRIPTION OF THE INVENTION

Embodiments of the present invention comprise flowing electrolyte systems and methods. Elements of the invention are illustrated in concise outline form in the drawings, showing only those specific details that are necessary to the understanding of the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

The reference to any prior art in this specification is not, and should not be taken as, an acknowledgement or any form of suggestion that the prior art forms part of the common general knowledge.

According to one aspect, the present invention resides in a flowing electrolyte battery system including: a power bus; a maintenance bus; a plurality of flowing electrolyte batteries switchedly connected to the power bus or the maintenance bus; and a bi-directional converter connecting the maintenance bus and the power bus, wherein the bi-directional converter includes a step-up mode, for creating a positive potential difference between the maintenance bus and the power bus, and a step-down mode, for creating a negative potential difference between the maintenance bus and the power bus.

Advantages of certain embodiments of the present invention include an ability to perform maintenance on part of a battery system, without affecting other parts of the battery system. For example, a battery system can continue to operate while one battery is stripped; a system can be maintained in a balanced state with all batteries having the same state of charge; or a battery can be tested (e.g., a capacity test) without stopping an entire battery system. Certain embodiments enable fully automated maintenance, error detection and error handling. Furthermore, several batteries can share these features, such that the cost and complexity of individual electronics for each battery is not required.

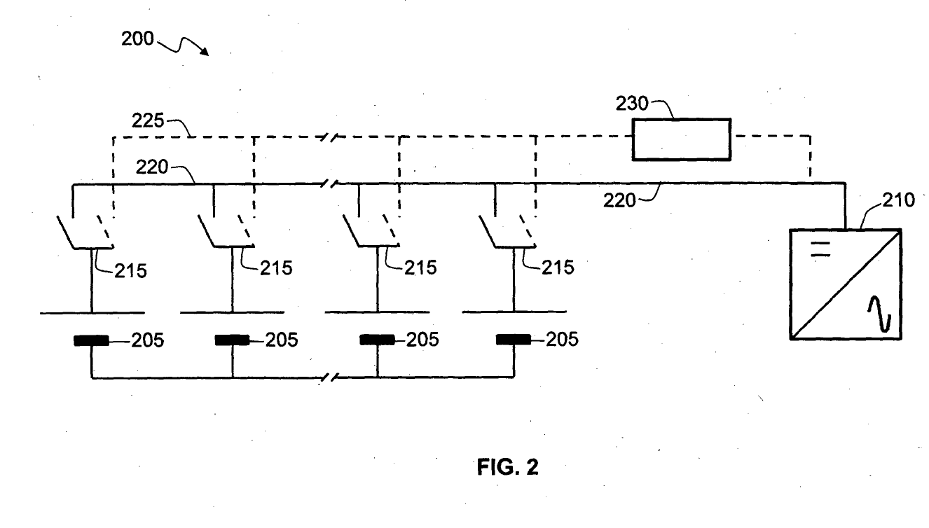

FIG. 2 illustrates a battery system 200, according to an embodiment of the present invention.

The battery system 200 includes a plurality of Zinc-Bromine batteries 205, each of which is switchedly connected to a bi-directional inverter 210 via a switch 215 and a bidirectional power direct current (DC) bus 220.

Each switch 215 enables connection of a Zinc-Bromine battery 205 of the plurality of Zinc-Bromine batteries 205 to the bidirectional power DC bus 220, to a bidirectional maintenance DC bus 225, or disconnected from both the bidirectional power DC bus 220 and the bidirectional maintenance DC bus 225.

The bidirectional DC bus 220 is connected to the bidirectional maintenance DC bus 225 via a bidirectional DC-DC converter 230.

In normal operation, the plurality of Zinc-Bromine batteries 205 are connected to the bidirectional DC bus 220 via the switches 215. A Zinc-Bromine battery 205 can then be disconnected from the bidirectional DC bus 220 and connected to the bidirectional maintenance DC bus 225 to perform one or more operations independently of the remaining Zinc-Bromine batteries 205 on to the bidirectional DC bus 220.

For example, a first Zinc-Bromine battery 205 of the plurality of Zinc-Bromine batteries 205 can be connected to the bidirectional maintenance DC bus 225, while the remaining batteries 205 of the plurality of Zinc-Bromine batteries 205 are connected to the bidirectional DC bus 220. The remaining batteries 205 can, for example, be receiving power from the bidirectional DC bus 220, i.e. are being charged, while the first Zinc-Bromine battery 205 is discharged and stripped as part of a maintenance procedure.

One or more Zinc-Bromine batteries 205 of the plurality of Zinc-Bromine batteries 205 can be connected to the bidirectional maintenance DC bus 225 at any time. The current transported by the bidirectional maintenance DC bus 225 can be considerably lower than the current normally conducted on the bidirectional DC bus 220, and may be controlled according to a maximum current rating of the DC-DC converter 230.

Examples of operations that can be performed on the bidirectional DC bus 220 include charge, discharge, and float (charge maintenance) operations. Examples of operations that can be performed on the bidirectional maintenance DC bus 225 include charge, discharge, and float operations, but also extraordinary operations such as accelerated discharge and strip, charge balancing, state of health measurement, series resistance and calibration.

Batteries 205 on the bidirectional maintenance DC bus 225 can be charged and discharged by adjusting the bidirectional DC-DC converter 230. The bidirectional DC-DC converter 230 includes a step-up mode, for creating a positive potential difference between the bidirectional maintenance DC bus 225 and the bidirectional DC bus 220, and a step-down mode, for creating a negative potential difference between the bidirectional maintenance DC bus 225 and the bidirectional DC bus 220. Those skilled in the art will understand that in some embodiments other equivalent hardware, such as a battery charger and a resistive load, can be substituted for the bidirectional DC-DC converter 230.

By creating a positive potential difference between the bidirectional maintenance DC bus 225 and the bidirectional DC bus 220, any batteries 205 on the bidirectional. DC bus 220 will be charged by batteries 205 on the bidirectional maintenance DC bus 225. Similarly, by creating a negative potential difference between the bidirectional maintenance DC bus 225 and the bidirectional DC bus 220, any batteries on the bidirectional maintenance DC bus 225 will be charged by batteries on the bidirectional DC bus 220. Accordingly, the charge and discharge steps can be efficiently performed without necessarily requiring connection to an external power source or power grid.

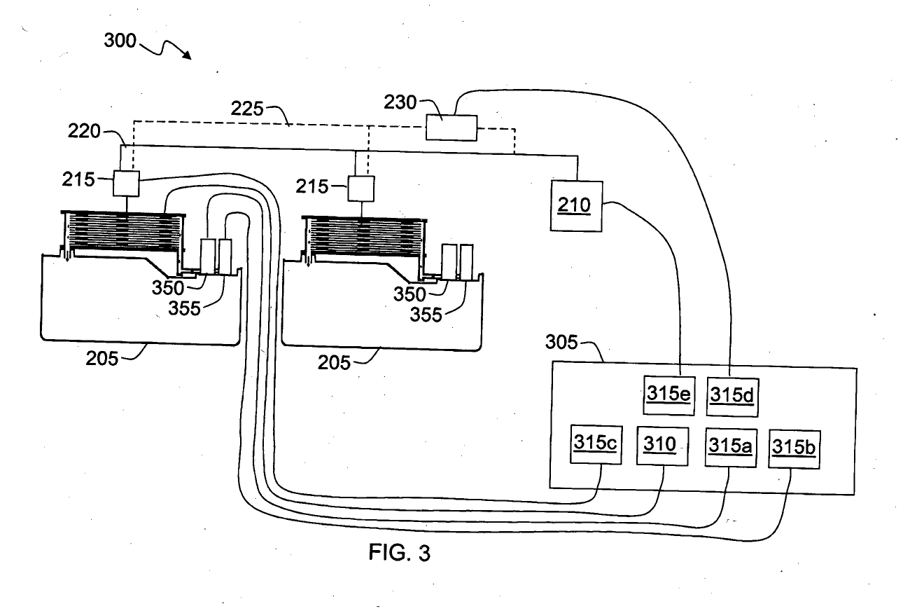

FIG. 3 illustrates a battery system 300, according to an embodiment of the present invention.

The battery system 300 includes the plurality of Zinc-Bromine batteries 205, the bi-directional inverter 210, the plurality of switches 215, the bidirectional power DC bus 220, the bidirectional maintenance DC bus 225, and the bidirectional DC-DC converter 230, similar to the battery system 200 of FIG. 2.

The battery system 300 further includes a controller 305, for controlling operation of the system 300.

The controller 305 includes a plurality of sensors 310 for measuring, for example, a voltage and resistance, stack temperature, tank temperature, ambient air temperature and leak detection of each of the plurality of Zinc-Bromine batteries 205, and a plurality of outputs 315a-e, for controlling one or more aspects of the system 300.

The plurality of outputs 315a-e include a zinc pump controller 315a, for controlling a zinc pump 350 of a Zinc-Bromine battery 205, a bromine pump controller 315b, for controlling a bromine pump 355 of the Zinc-Bromine battery 205, a switch controller 315c, for controlling the switch 215 corresponding with the Zing-Bromine battery 205, a DC-DC controller 315d, for controlling the bidirectional DC-DC converter 230, and an inverter controller 315e, for controlling the bi-directional inverter 210.

The controller 305 has several features, including maintenance and protection features, as described further below.

The controller 305 protects the Zinc-Bromine batteries 205 from overcharge and/or overdischarge by monitoring their corresponding voltages using the plurality of sensors 310, and adjusting the bi-directional inverter 210 through the inverter controller 315e. Alternatively or additionally, Zinc-Bromine batteries 205 can be added to or removed from the bidirectional power DC bus 220 by the switch controller 315c.

The controller 305 is also used for charge maintenance. Fully charged Zinc-Bromine batteries 205 are disconnected from the bidirectional power DC bus 220 using the switch controller 315c. The zinc pump 350 and the bromine pump 355 are turned off using the zinc pump controller 315a and the bromine pump controller 315b. The zinc pump and/or bromine pump 350 is turned on periodically using the zinc pump controller 315a during float operation. Additionally, the controller 305 periodically connects the Zinc-Bromine batteries 205 to the bidirectional power DC bus 220 using the switch controller 315c for short charge cycles, helping the Zinc-Bromine batteries 205 to maintain their charge. The zinc pump 350 is typically turned on and off periodically at a higher frequency than the periodic charge cycles.

When all Zinc-Bromine batteries 205 are charged, they may all be disconnected from the bidirectional power DC bus 220 using the switch controller 315c. If battery power is needed, one or more of the Zinc-Bromine batteries 205 are reconnected to the bidirectional power DC bus 220 using the switch controller 315c, and can be discharged.

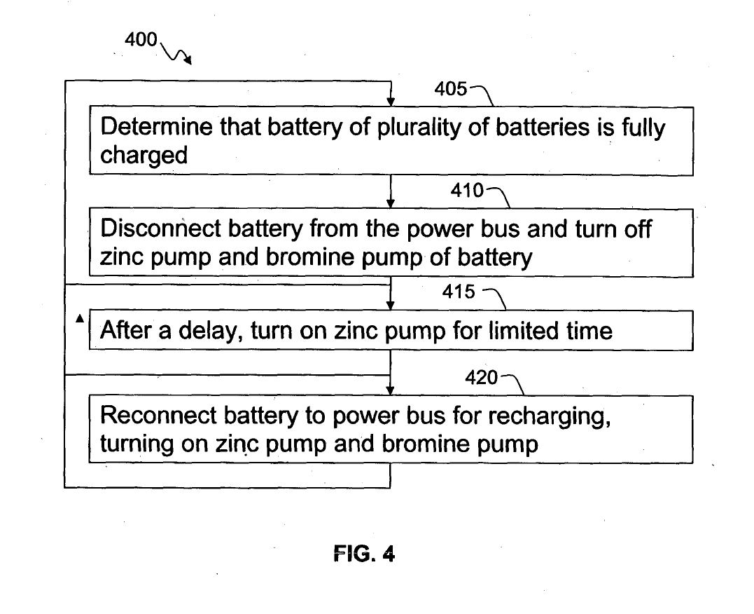

FIG. 4 illustrates a method 400 of charge maintenance, according to an embodiment of the present invention.

At step 405, it is determined that a battery 205 of the plurality of Zinc-Bromine batteries 205 is fully charged.

At step 410, the battery 205 is disconnected from the bidirectional power DC bus 220 and the zinc pump 350 and bromine pump 355 are turned off.

At step 415, the zinc pump 350 is turned on for a limited period after a delay. Step 415 can be repeated a number of times, resulting in a periodic operation of the zinc pump 350. As will be readily understood by the skilled addressee, the zinc pump 350 need not be run at a particular periodicity, but instead can be run according to a semi-random schedule, dependant on a number of battery or system inputs.

At step 420, the battery 205 is reconnected to the bidirectional power DC bus 220 for recharging.

Steps 405-420 can be repeated any number of times until the battery 205 is needed.

The controller 305 is also used to provide a stripping function to the Zinc-Bromine batteries 205, which can be done without shutting down the system 300.

The Zinc-Bromine battery 205 is disconnected from the bidirectional power DC bus 220 and connected to the bidirectional maintenance power DC bus 225 using the switch controller 315c. The Zinc-Bromine battery 205 is then discharged in constant current mode, such as 50 amperes, onto the bidirectional power DC bus 220 via the bidirectional DC-DC converter 230, until a voltage of the Zinc-Bromine battery 205 reaches a low threshold.

A further example of the constant current is 50 milliamperes per square centimetre of electrode. An example of the low threshold is 1 volt. A further example of the low threshold is 0.05 volt per cell of the Zinc-Bromine battery 205.

The Zinc-Bromine battery 205 is then short circuited until zero volts/zero amperes is maintained for a period of, for example, 30 minutes.

The Zinc-Bromine battery 205 can be then reconnected to the bidirectional power DC bus 220 and charged, or alternatively charged on the bidirectional maintenance DC bus 225.

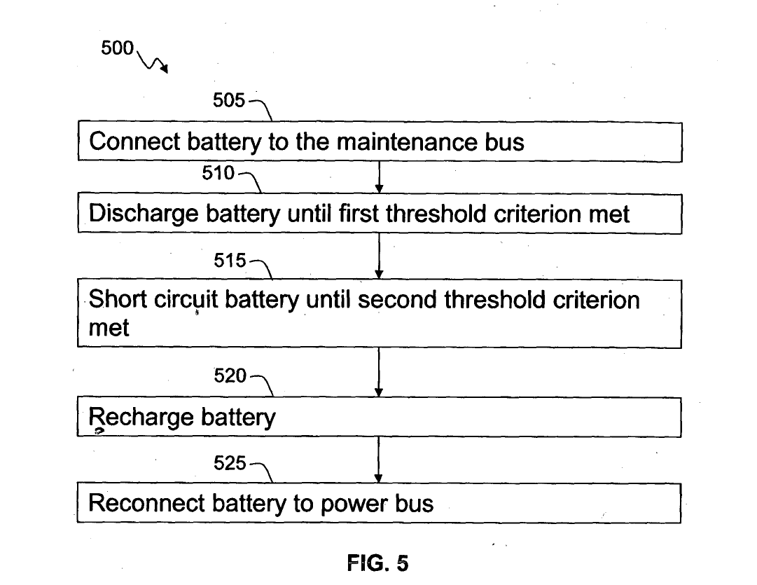

FIG. 5 illustrates a method 500 of maintaining a battery 205, according to an embodiment of the present invention.

At step 505, a battery 205 of the plurality of Zinc-Bromine batteries 205 is connected to the bidirectional maintenance power DC bus 225.

At step 510, the battery 205 is discharged until a first threshold criterion is met. An example of the first threshold criterion is 1 volt measured across the battery 205. Discharge of the battery 205 can be performed by adjusting the bidirectional DC-DC converter 230 in order to create a voltage drop from the maintenance power DC bus 225 to the bidirectional power DC bus 220.

At step 515, the battery 205 is short-circuited until a second threshold criterion is met. An example of a second threshold criterion is 0V across the battery 205 for 30 minutes.

At step 520, the battery 205 is recharged to the level of the other batteries, or to a full state of charge (SoC). Discharge of the battery 205 can be performed by adjusting the bidirectional DC-DC converter 230 in order to create a voltage increase from the maintenance power DC bus 225 to the power DC bus 220.

At step 525, the battery 205 is reconnected to the bidirectional power DC bus 220 and can be used again.

The controller 305 also provides a charge balancing between the plurality of Zinc-Bromine batteries 205. The controller 305 measures a voltage, or SoC, of each Zinc-Bromine battery 205, and compares it to the voltages, or SoCs, of the other batteries 205 to determine an imbalance. An imbalance can, for example, be determined where a voltage difference between a first Zinc-Bromine battery 205 and a second Zinc-Bromine battery 205 is greater than a threshold value.

If at any time, a Zinc-Bromine battery 205 has a higher or lower voltage than the other Zinc-Bromine batteries 205 connected to the bidirectional power DC bus 220, it can be disconnected from the bidirectional power DC bus 220 and connected to the bidirectional maintenance DC bus 225 using the switch controller 315c.

The bidirectional DC-DC converter 230 is then configured such that the Zinc-Bromine battery 205 is charged or discharged to the same voltage as the other Zinc-Bromine batteries 205 that are connected to the bidirectional power DC bus 220.

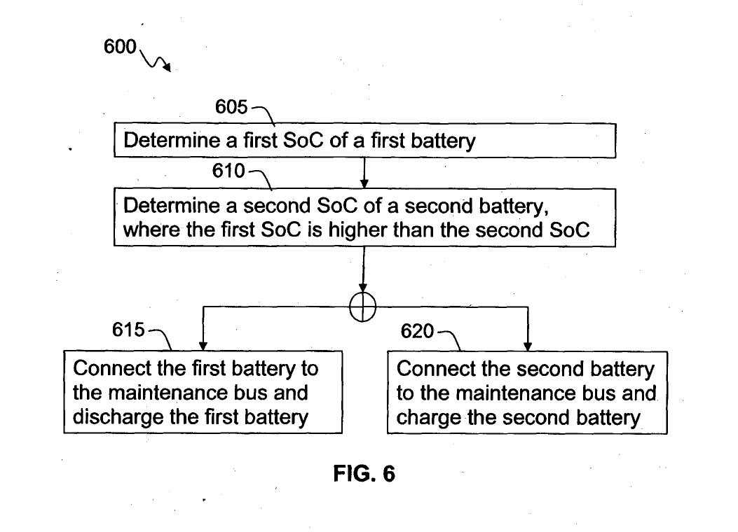

FIG. 6 illustrates a method 600 of balancing batteries, according to an embodiment of the present invention.

At step 605, a first voltage of a first battery 205 of the plurality of zinc-bromine batteries 205 is determined. The first battery is connected to the power bus.

At step 610, a second voltage of a second battery 205 of the plurality of zinc-bromine batteries 205 is determined, wherein the first voltage is higher than the second voltage.

At step 615, the first battery 205 is connected to the bidirectional maintenance DC bus 225 and discharged. At step 620 the second battery is connected to the bidirectional maintenance DC bus 225 and charged. Either step 615 or step 620 is performed until the first battery 205 and the second battery 205 have similar voltages.

As will be readily understood by the skilled reader, the method can be applied to systems including several batteries. In this case, either the first battery 205 or the second battery 205 can comprise an average of several batteries 205, for example.

Health measurements can also be performed on a Zinc-Bromine battery 205, without substantially affecting operation of the system 300. This is performed by disconnecting the Zinc-Bromine battery 205 from the bidirectional power DC bus 220, and performing the health measurements on the bidirectional maintenance DC bus 225.

A Zinc-Bromine battery 205 can be charged and discharged at selected currents and voltages by adjusting the bidirectional DC-DC converter 230. Alternatively or additionally, series resistance measurements may be made on a Zinc-Bromine battery 205. For example, at a range of states of charge, a full range of currents (e.g., −50 to +50 amps) can be applied to a battery 205 and the associated voltage can be measured. From these measurements a series resistance map can be calculated over a wide operating range of the battery 205. This in turn can indicate the state of health, or wear of various battery components.

Alternatively or additionally, a calibration cycle can be performed on a Zinc-Bromine battery 205 in order to assess the DC efficiency of the Zinc-Bromine battery 205. For example, a standard charge/discharge cycle is one of the best indicators of the state of health and of the wear of a battery. Such a cycle can provide data for efficiency measurements, which in turn provide indicators concerning the state of different components of the battery (e.g., separators, and bromine and zinc electrodes).

During the health measurements, the other Zinc-Bromine batteries 205 continue to follow ordinary operation and the operation of the system 300 is not substantially affected.

When the health measurements are completed, the Zinc-Bromine battery 205 is disconnected from the bidirectional maintenance DC bus 225 and either reconnected to the bidirectional power DC bus 220 or left disconnected from both the bidirectional maintenance DC bus 225 and the bidirectional power DC bus 220 for service.

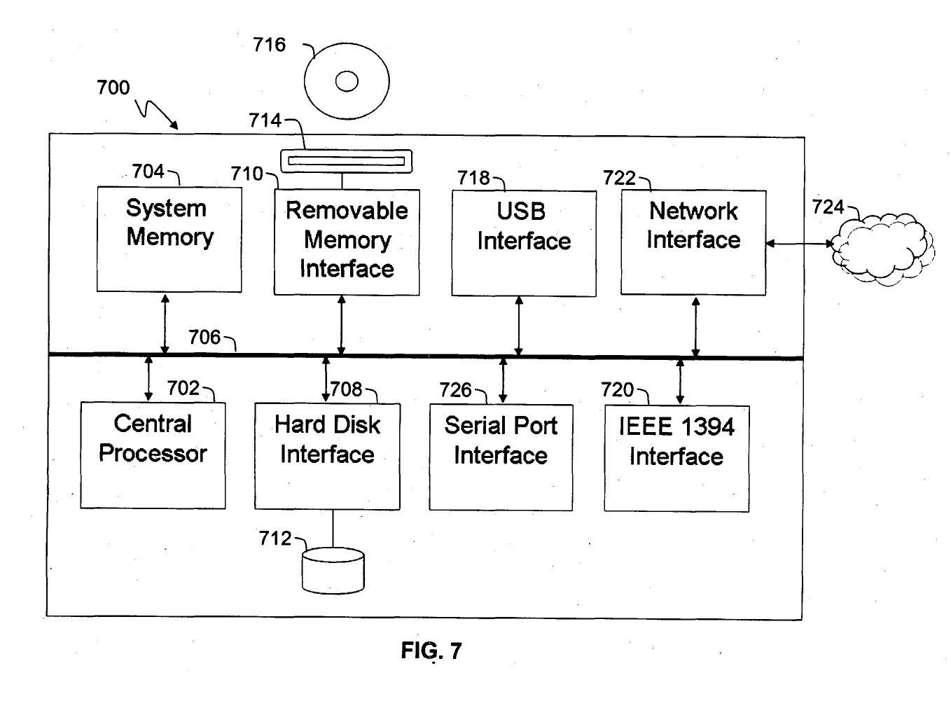

FIG. 7 diagrammatically illustrates a controller 700, according to an embodiment of the present invention. The controller 700 can be identical or similar to the controller 305 of FIG. 3, and the methods 400, 500 of FIG. 4 and FIG. 5 can be implemented using the controller 700.

The controller 700 includes a central processor 702, a system memory 704 and a system bus 706 that couples various system components, including coupling the system memory 704 to the central processor 702. The system bus 706 may be any of several types of bus structures including a memory bus or memory controller, a peripheral bus, and a local bus using any of a variety of bus architectures. The structure of system memory 704 is well known to those skilled in the art and may include a basic input/output system (BIOS) stored in a read only memory (ROM) and one or more program modules such as operating systems, application programs and program data stored in random access memory (RAM).

The controller 700 can also include a variety of interface units and drives for reading and writing data. The data can include, for example, a first and second threshold criterion, details of the plurality of zinc-bromine batteries 205, or any other suitable data.

In particular, the controller 700 includes a hard disk interface 708 and a removable memory interface 710, respectively coupling a hard disk drive 712 and a removable memory drive 714 to the system bus 706. A single hard disk drive 712 and a single removable memory drive 714 are shown for illustration purposes only and with the understanding that the computing device 700 can include only a single memory, or alternatively several similar drives.

The controller 700 may include additional interfaces for connecting devices or sensors to the system bus 806. FIG. 7 shows a universal serial bus (USB) interface 718 which may be used to couple a device or sensor to the system bus 706. For example, an IEEE 1394 interface 720 may be used to couple additional devices to the computing device 700. Examples of additional devices include switches 215 or switch controllers, and examples of sensors include voltage and temperature sensors.

The computing device 700 can operate in a networked environment using logical connections to one or more remote computers or other devices, such as a server, a router, a network personal computer, a peer device or other common network node, a wireless telephone or wireless personal digital assistant. The controller 700 includes a network interface 722 that couples the system bus 706 to a local area network (LAN) 724. A wide area network (WAN), such as the Internet, can also be accessed by the computing device, for example via a modem unit connected to a serial port interface 726 or via the LAN 724. This is advantageous when, for example, the controller 700 is able to be updated, or if data is made available by the controller 700.

Transmission of images and/or video can be performed using the LAN 724, the WAN, or a combination thereof.

It will be appreciated that the network connections shown and described are exemplary and other ways of establishing a communications link between computers can be used. The existence of any of various well-known protocols, such as TCP/IP, Frame Relay, Ethernet, FTP, HTTP and the like, is presumed, and the controller 700 can be operated in a client-server configuration to permit a user to retrieve data from, for example, a web-based server.

The operation of the controller 700 can be controlled by a variety of different program modules. Examples of program modules are routines, programs, objects, components, and data structures that perform particular tasks or implement particular abstract data types. The present invention may also be practiced with other computer system configurations, including hand-held devices, multiprocessor systems, microprocessor-based or programmable consumer electronics, network PCs, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

In summary, advantages of certain embodiments of the present invention include an ability to perform maintenance on part of a battery system 200, 300, without affecting other parts of the battery system. Certain embodiments enable fully automated maintenance, error detection and error handling. Furthermore, several battery modules can share these features, such that the cost and complexity of individual electronics for each battery is not required.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

The claims defining the invention are:

1. A flowing electrolyte battery system including:
a power bus;
a maintenance bus;
a plurality of flowing electrolyte batteries switchedly connected to the power bus or the maintenance bus; and
a bi-directional converter connecting the maintenance bus and the power bus,
wherein the bi-directional converter includes a step-up mode, for creating a positive potential difference between the maintenance bus and the power bus, and a step-down mode, for creating a negative potential difference between the maintenance bus and the power bus.

2. The flowing electrolyte battery system of claim 1, further including:
a bidirectional inverter connected to the power bus, for converting between direct current (DC) of the power bus and alternating current (AC) of an external power network.

3. The flowing electrolyte battery system of claim 1, further including a controller, the controller including:
a sensor, for receiving a measurement of a flowing electrolyte battery of the plurality of flowing electrolyte batteries; and
at least one output, for regulating a component of the system;
wherein the output is controlled according to the received measurement.

4. The flowing electrolyte battery system of claim 3, wherein the measurement includes at least one of a voltage and a resistance of a battery of the plurality of flowing electrolyte batteries.

5. The flowing electrolyte battery system of claim 4, wherein the measurement includes at least one of a voltage and a resistance of each battery of the plurality of flowing electrolyte batteries.

6. The flowing electrolyte battery system of claim 3, wherein the component of the system includes one of a switch, a pump of the battery and the bi-directional converter.

7. The flowing electrolyte battery system of claim 3, wherein the controller further includes:
a processor, coupled to the sensor and the output; and
a memory, coupled to the processor, including program code executable by the processor for performing maintenance procedures.

8. The flowing electrolyte battery system of claim 7, wherein the maintenance procedures include:
determining that a battery of the plurality of zinc-bromine batteries is fully charged;
disconnecting the battery from the power bus and turning off a zinc pump and a bromine pump of the battery;
periodically running the zinc pump while the battery is disconnected from the power bus; and
periodically reconnecting the battery to the power bus for recharging, wherein the zinc pump and the bromine pump are turned on during recharging.

9. The flowing electrolyte battery system of claim 7, wherein the maintenance procedures include:
connecting a battery to the maintenance bus;
discharging the battery until a first threshold criterion is reached;
short circuiting the battery until a second threshold criterion is reached;
recharging the battery; and
connecting the battery to the power bus.

10. The flowing electrolyte battery system of claim 7, wherein the maintenance procedures include balancing the State of Charge (SoC) of the batteries by:
determining a first SoC of a first battery of the plurality of flowing electrolyte batteries, wherein the first battery is connected to the power bus;
determining a second SoC of a second battery of the plurality of flowing electrolyte batteries, wherein the second battery is connected to the power bus and the first SoC is higher than the second SoC; and
performing one of:
connecting the first battery to the maintenance bus and discharging the first battery; or
connecting the second battery to the maintenance bus and charging the second battery.

11. A method of maintaining a flowing electrolyte battery system, wherein the flowing electrolyte battery system includes a plurality of zinc-bromine batteries, each of the plurality of zinc-bromine batteries switchedly connected to a power bus and a maintenance bus, the method including:
determining that a battery of the plurality of zinc-bromine batteries is fully charged;
disconnecting the battery from the power bus and turning off a zinc pump and a bromine pump of the battery;
periodically running the zinc pump while the battery is disconnected from the power bus; and
periodically reconnecting the battery to the power bus for recharging, including turning on the zinc pump and the bromine pump during recharging.

12. The method of claim 11, further including:
connecting the battery to the maintenance bus;
discharging the battery until a first threshold criterion is reached;
short circuiting the battery until a second threshold criterion is reached;
recharging the battery; and
reconnecting the battery to the power bus.

13. The method of claim 12, wherein discharging the battery comprises creating a positive potential difference between the maintenance bus and the power bus by a direct current (DC)-DC converter.

14. The method of claim 12, wherein the battery is discharged at a constant current.

15. The method of claim 14, wherein the constant current is about 50 milliamperes per square centimetre of electrode.

16. The method of claim 12, wherein the first threshold criterion is about 0.05 volt per cell across the battery.

17. The method of claim 12, wherein the second threshold criterion is about 0 volt across the battery maintained for a period of about 30 minutes.

18. The method of claim 12, wherein recharging the battery comprises charging the battery using the maintenance bus.

19. The method of claim 18, wherein recharging the battery comprises creating a negative potential difference between the maintenance bus and the power bus by a direct current (DC)-DC converter and charging the battery to a specific SoC.

20. The method of claim 19, wherein the specific SoC comprises a SoC of another battery on the power bus.

21. The method of claim 12, wherein recharging the battery comprises charging the battery using the power bus.

22. The method of claim 11, further including:
determining a first SoC of a first battery of the plurality of zinc-bromine batteries, wherein the first battery is connected to the power bus;
determining a second SoC of a second battery of the plurality of zinc-bromine batteries, wherein the second battery is connected to the power bus, wherein the first SoC is higher than the second SoC; and
performing one of:
connecting the first battery to the maintenance bus and discharging the first battery; or
connecting the second battery to the maintenance bus and charging the second battery.

23. A flowing electrolyte battery system including:
a power bus;
a maintenance bus;
a plurality of flowing electrolyte batteries switchedly connected to the power bus or the maintenance bus; and
a power converter connecting the maintenance bus and the power bus,
wherein the power converter is configurable to generate a potential difference between the power bus and the maintenance bus such that batteries that are connected to the maintenance bus are charged.

24. The flowing electrolyte battery system of claim 23, wherein the power converter is configurable to convert between an alternating current of an external power network or a direct current of the power bus to a direct current of the maintenance bus, and wherein an electrical load is used to discharge any batteries that are connected to the maintenance bus.
